(19) United States
(12) Patent Application Publication
(10) Pub. No.: US 2025/0271677 A1
(43) Pub. Date: Aug. 28, 2025

(54) HEAD-MOUNTABLE DEVICES WITH CONNECTABLE LENS ASSEMBLY

(71) Applicant: Apple Inc., Cupertino, CA (US)

(72) Inventors: Paul X. WANG, Cupertino, CA (US); John CAGLE, San Jose, CA (US)

(21) Appl. No.: 18/857,434

(22) PCT Filed: Jun. 9, 2023
(86) PCT No.: PCT/US2023/025005

§ 371 Date: Oct. 16, 2024

Related U.S. Application Data
(60) Provisional application No. 63/352,949, filed on Jun. 16, 2022.

(51) Int. Cl. G02B 27/01

(52) U.S. Cl. CPC G02B 27/0176

(57) ABSTRACT

A head-mountable device can include assemblies that provide vision correction with lenses. By providing head-mountable devices with modular features, certain lens assemblies can provide the desired vision correction for any given user and facilitate exchange with a different lens assembly for a different user. Within given assemblies, a lens or lenses can be moved within the corresponding housing such that they move with respect to other structures, such as other lenses and/or a display. Such movements can be managed by an elastic support that initially provides stability to the lens but can deform to allow the lens to move through the elastic support when sufficient force in a particular direction is applied.

### CROSS-REFERENCE TO RELATED APPLICATIONS

The present application claims the benefit of U.S. Provisional Patent Application Ser. No. 63/352,949, entitled “HEAD-MOUNTABLE DEVICES WITH CONNECTABLE LENS ASSEMBLY,” filed Jun. 16, 2022, which is hereby incorporated herein by reference in its entirety and made part of the present U.S. Utility patent application for all purposes.

### TECHNICAL FIELD

The present description relates generally to head-mountable devices, and, more particularly, to head-mountable devices with connectable lens assemblies.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a rear view of the head-mountable device of FIG. 1, according to some embodiments of the present disclosure.

FIG. 3 illustrates an exploded perspective view of a lens assembly and an optical assembly of the head-mountable device of FIG. 1, according to some embodiments of the present disclosure.

FIG. 4 illustrates a perspective view of the lens assembly and the optical assembly of FIG. 3, according to some embodiments of the present disclosure.

FIG. 5 illustrates a sectional view of a lens assembly and an optical assembly of a head-mountable device, according to some embodiments of the present disclosure.

FIG. 6 illustrates a sectional view of the lens assembly and the optical assembly of FIG. 5 with the lens of the lens assembly in an adjusted position, according to some embodiments of the present disclosure.

FIG. 7 illustrates a sectional view of a lens assembly, such as the lens assembly of FIG. 5, according to some embodiments of the present disclosure.

FIG. 8 illustrates a sectional view of an alternate lens assembly, such as the lens assembly of FIG. 5, according to some embodiments of the present disclosure.

FIG. 9 illustrates a sectional view of a lens assembly and an optical assembly of a head-mountable device, according to some embodiments of the present disclosure.

FIG. 10 illustrates a sectional view of the lens assembly and the optical assembly of FIG. 5 with the lens of the lens assembly in an adjusted position, according to some embodiments of the present disclosure.

FIG. 11 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device.

Many of the functions performed by a head-mountable device are optimally experienced when the output is tailored to the needs of the user wearing the head-mountable device. In particular, the visual output features of a head-mountable device can be provided in a manner that accommodates a user's vision, including vision deficiencies and/or needs for vision correction. For example, a head-mountable device can include or be combinable with corrective lenses that allow a user to properly view the visual output features of the head-mountable device. To allow a given head-mountable device can be used by different users, the corrective lenses can be provided as a separate assembly that is attachable, adjustable, removable, and/or exchangeable with other corrective lenses. Accordingly, any given user can properly view the visual output features when using the head-mountable device with an appropriate corresponding set of corrective lenses.

Systems, devices, and methods of the present disclosure can provide a head-mountable device with assemblies that provide vision correction with lenses. By providing head-mountable devices with modular features, certain lens assemblies can provide the desired vision correction for any given user and facilitate exchange with a different lens assembly for a different user. Within given assemblies, a lens or lenses can be moved within the corresponding housing such that they move with respect to other structures, such as other lenses and/or a display. Such movements can be managed by an elastic support that initially provides stability to the lens but can deform to allow the lens to move through the elastic support when sufficient force in a particular direction is applied.

These and other embodiments are discussed below with reference to FIGS. 1-11. However, those skilled in the art will readily appreciate that the detailed description given herein with respect to these Figures is for explanatory purposes only and should not be construed as limiting.

According to some embodiments, for example as shown in FIG. 1, a head-mountable device 10 includes an HMD assembly 100 with a frame 110 that is worn on a head of a user. The frame 110 can be positioned in front of the eyes of a user to provide information within a field of view of the user. The HMD assembly 100 can provide nose pads or another feature to rest on a user's nose and/or engage other parts of the user's face.

The frame 110 can be supported on a user's head with the head engager 120. The head engager 120 can wrap or extend along opposing sides of a user's head. The head engager 120 can optionally include earpieces for wrapping around or otherwise engaging or resting on a user's ears. It will be appreciated that other configurations can be applied for securing the head-mountable device 10 to a user's head. For example, one or more bands, straps, belts, caps, hats, or other components can be used in addition to or in place of the illustrated components of the head-mountable device 10. By further example, the head engager 120 can include multiple components to engage a user's head.

The frame 110 can provide structure around a peripheral region thereof to support any internal components of the HMD assembly 100 in their assembled position. For example, the frame 110 can enclose and support various internal components (including for example integrated circuit chips, processors, memory devices and other circuitry) to provide computing and functional operations for the head-mountable device 10, as discussed further herein. While several components are shown within the frame 110, it will be understood that some or all of these components can be located anywhere within or on the head-mountable device 10. For example, one or more of these components can be positioned within the head engager 120 of the head-mountable device 10.

The frame 110 can include and/or support one or more cameras 130. The cameras 130 can be positioned on or near an outer side 112 of the frame 110 to capture images of views external to the head-mountable device 10. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 10 can include optical assemblies 140 that provide visual output for viewing by a user wearing the head-mountable device 10. One or more optical assemblies 140 can be positioned on or near an inner side 114 of the frame 110. As used herein, an inner side 114 of a portion of a head-mountable device is a side that faces toward the user and/or away from the external environment.

An optical assembly 140 can transmit light from a physical environment (e.g., as captured by a camera) for viewing by the user. Such an optical assembly 140 can include optical properties, such as lenses for vision correction based on incoming light from the physical environment. Additionally or alternatively, an optical assembly 140 can provide information as a display within a field of view of the user. Such information can be provided to the exclusion of a view of a physical environment or in addition to (e.g., overlaid with) a physical environment.

A physical environment relates to a physical world that people can sense and/or interact with without necessarily requiring the aid of an electronic device. A computer-generated reality environment relates to a wholly or partially simulated environment that people sense and/or interact with the assistance of an electronic device. Examples of computer-generated reality include mixed reality and virtual reality. Examples of mixed realities can include augmented reality and augmented virtuality. Some examples of electronic devices that enable a person to sense and/or interact with various computer-generated reality environments include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable device can have an integrated opaque display, have a transparent or translucent display, or be configured to accept an external opaque display (e.g., smartphone).

Referring again to FIG. 1, the head-mountable device can include one or more lens assemblies 200. The lens assembly 200 can be or include one or more lenses for providing corrective vision capabilities. It will be understood that, where multiple lenses are used, the lenses of the lens assembly 200 can be provided together or separately (e.g., for combination). One lens assembly 200 can be applied to each of multiple (e.g., two) optical assemblies 140, as described further herein.

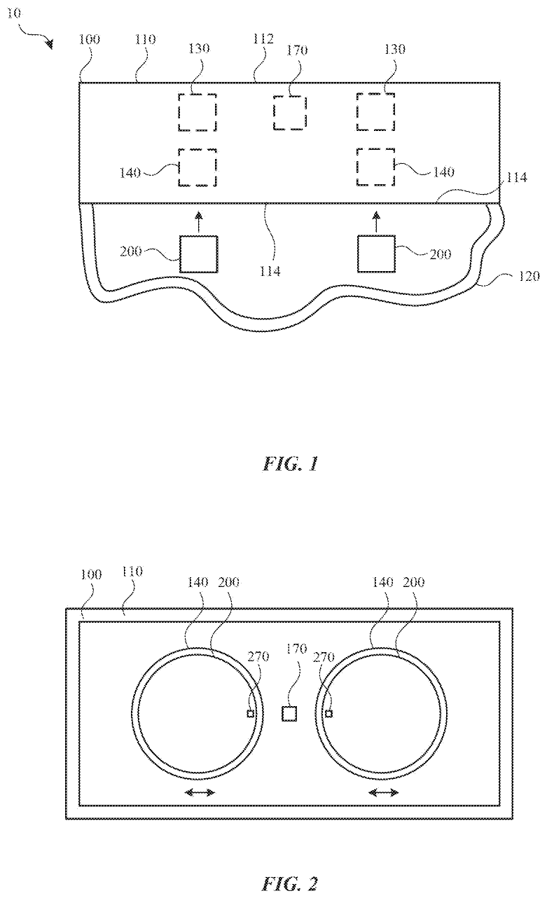

Referring now to FIG. 2, the optical assemblies of the head-mountable device can be adjustable to accommodate the facial features of the user wearing the head-mountable device and align each optical assembly with a corresponding eye of the user.

As shown in FIG. 2, the frame 110 can support a sensor 170. The sensor 170 can be positioned and arranged to detect a characteristic of the user, such as facial features. For example, such a user sensor can perform facial feature detection, facial movement detection, facial recognition, eye tracking, user mood detection, user emotion detection, voice detection, and the like.

As further shown in FIG. 2, each optical assembly 140 can be adjusted to align with a corresponding eye of the user. For example, each optical assembly 140 can be moved along one or more axes until a center of each optical assembly 140 is aligned with a center of the corresponding eye. Accordingly, the distance between the optical assemblies 140 can be set based on an interpupillary distance (“IPD”) of the user. IPD is defined as the distance between the centers of the pupils of a user's eyes.

The pair of optical assemblies 140 can be mounted to the frame 110 and separated by a distance. The distance between the pair of optical assemblies 140 can be designed to correspond to the IPD of a user. The distance can be adjustable to account for different IPDs of different users that may wear the head-mountable device 10. For example, either or both of the optical assemblies 140 may be movably mounted to the frame 110 to permit the optical assemblies 140 to move or translate laterally to make the distance larger or smaller. Any type of manual or automatic mechanism may be used to permit the distance between the optical assemblies 140 to be an adjustable distance. For example, the optical assemblies 140 can be mounted to the frame 110 via slidable tracks or guides that permit manual or electronically actuated movement of one or more of the optical assemblies 140 to adjust the distance there between.

Additionally or alternatively, the optical assemblies 140 can be moved to a target location based on a desired visual effect that corresponds to user's perception of the optical assembly 140 when it is positioned at the target location. The target location can be determined based on a focal length of the user and/or optical components of the system. For example, the user's eye and/or optical components of the system can determine how the visual output of the optical assembly 140 will be perceived by the user. The distance between the optical assembly 140 and the user's eye and/or the distance between the optical assembly 140 and one or more optical components can be altered to place the optical assembly 140 at, within, or outside of a corresponding focal distance. Such adjustments can be useful to accommodate a particular user's eye, corrective lenses, and/or a desired optical effect.

The sensor 170 and/or another sensor can be operated to detect a marker 270 of the lens assembly 200. For example, the markers 270 can include features that are detectable by the sensor 170 and/or another sensor. The markers 270 can be used to identify the optical assembly 200, a lens thereof, an optical property of the lens, an identity of an owner (e.g., to whom a prescription lens applies), and the like. For example, markers 270 can include emitters, patterns, symbols, text (alpha and/or numeric), images, barcodes (e.g., Universal Product Code), QR codes, and the like. Such indicators may be formed as patterns of contrasting dark (e.g., black) and light (e.g., white) portions. It will be understood that such symbols can be provided within or outside the visible spectrum of the human eye. Where the markers 270 emit or reflect light outside of the visible spectrum, it can be non-visible to a user. For example, the markers 270 can include ultraviolet-reflective ink and/or infrared-reflective ink. As such, the markers 270 can provide identification capabilities without being noticeable by a user.

The sensor 170 and/or another sensor can detect the marker 270 and determine a position of a lens or other optical component with respect to another component, such as the housing of the lens assembly 200. Where the lens is moved or should be moved, the sensor 170 and/or another sensor can detect the movement and provide a notification to alert the user, for example if a different target position is recommended.

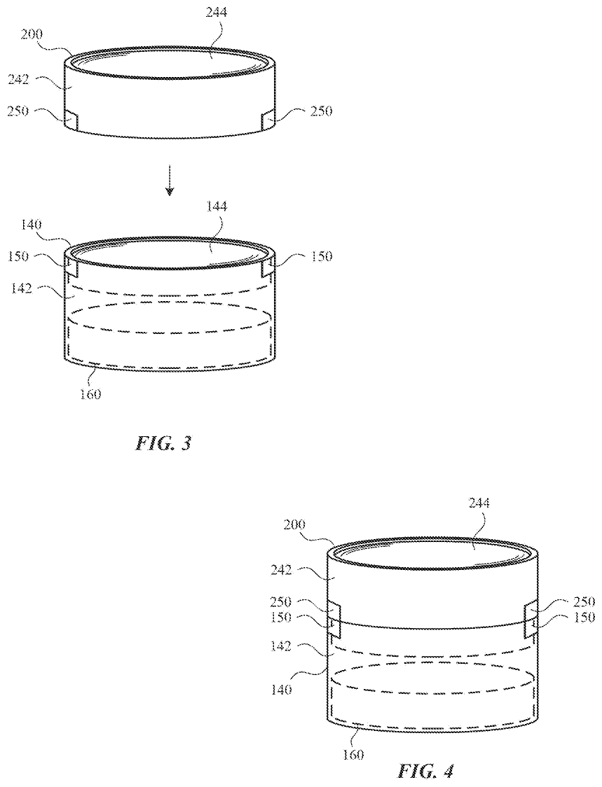

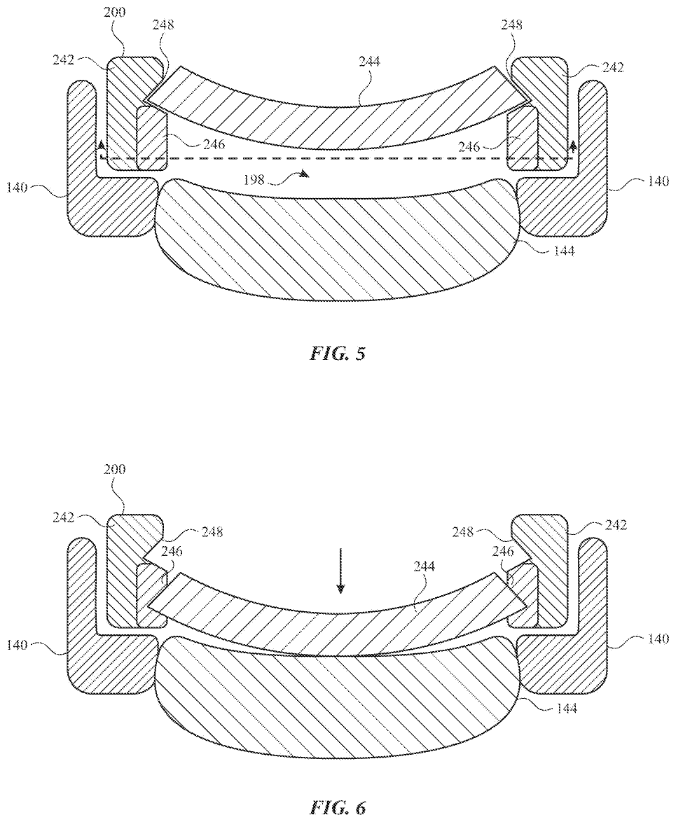

Referring now to FIGS. 3 and 4, a lens assembly can be coupled to an optical assembly. It will be understood that the assemblies described herein can facilitate configurations of being connected, installed, removed, swapped, and/or exchanged by a user in conjunction with another assembly, such as an optical assembly of a head-mounted device. Connection of a lens assembly with an optical assembly can be performed and reversed, followed by disconnection and connection of another lens assembly with the same optical assembly or another optical assembly with the same lens assembly. As such, multiple lens assemblies can be exchangeable with each other with respect to a given optical assembly. Further, multiple optical assemblies can be used with any given lens assembly.

A lens assembly can be connected to an optical assembly in a manner that allows the lens assembly to be removed thereafter. The connection can be fully reversible, such that when the lens assembly and the optical assembly are disconnected, each is restored to a condition held prior to the connection. The connection can be fully repeatable, such that after the lens assembly and the optical assembly are disconnected, the same or a different optical assembly and lens assembly pair can be connected in the same way.

As shown in FIG. 3, each optical assembly 140 can include a display 160 within an optical assembly housing 142. The optical assembly housing 142 can surround an outer periphery of the display 160 and provide support thereto. Additionally, the optical assembly housing 142 can define at least a portion of a periphery of the optical assembly 140.

The display 160 of the optical assembly 140 can be operated to display visual information for a user. For example, the display 160 can provide visual (e.g., image or video) output by utilizing, for example, digital light projection, OLEDs, LEDs, uLEDs, liquid crystal on silicon, laser scanning light source, or any combination of these technologies.

Each optical assembly 140 can further include a first lens 144 within the optical assembly housing 142. The optical assembly housing 142 can surround an outer periphery of the first lens 144 and provide support thereto. Additionally, the optical assembly housing 142 can define at least a portion of a periphery of the optical assembly 140.

As further shown in FIG. 3, each lens assembly 200 can also include a second lens 244 within a lens assembly housing 242. The lens assembly housing 242 can surround an outer periphery of the second lens 244 and provide support thereto. Additionally, the lens assembly housing 242 can define at least a portion of a periphery of the lens assembly 200.

The first lens 144 and/or second lens 244 can provide one or more types of optical effects and/or vision correction. Lenses 144 and/or 244 can include other optical components as required to produce a desired optical effect. For example, lenses 144 and/or 244 can provide vision correction to light as appropriate for a given user. Such correction can be spherical, aspheric, atoric, cylindrical, single vision, multifocal, progressive, and/or adjustable. By further example, lenses 144 and/or 244 can include one or more diffusers, filters, polarizers, prisms, beam splitters, diffraction gratings, mirrors, and/or windows. The differences in correction or other effects among second lenses 244 of different lens assemblies 200 can include variations in type of correction, diopter power, axis of correction, and the like. Various combinations of corrections can be provided with different lens assemblies 200. Accordingly, different users can use different lens assemblies 200 and/or no lens assembly 200 as desired.

The lens assembly 200 can include one or more lens assembly connectors 250 (e.g., magnets) supported by the lens assembly housing 242, and the optical assembly 140 can include one or more optical assembly connectors 150 (e.g., magnets) supported by the optical assembly housing 142. The lens assembly connectors 250 and the optical assembly connectors 150 can facilitate coupling of the lens assembly 200 to the optical assembly 140 in a relative position and orientation that aligns the second lens 244 of the lens assembly 200 in a preferred position and orientation relative to the display 160 of the optical assembly 140. For example, the lens assembly connectors 250 can releasably engage optical assembly connectors 150 of the optical assembly 140 to couple the lens assembly 200 to the optical assembly 140. It will be understood that such placement can allow the lens assembly 200 to be securely held in any location that places the second lens 244 within a field of view of the user and/or between the user and the display 160 of the optical assembly 140.

One or more of various connectors can be provided to secure the assemblies to each other. For example, mechanisms such as locks, latches, snaps, slides, channels, screws, clasps, threads, magnets, pins, an interference (e.g., friction) fit, knurl presses, bayoneting, fused materials, weaves, knits, braids, hook and loop fasteners, and/or combinations thereof can be included to couple and/or secure the assemblies together. The assemblies can remain secured to each other until an optional release mechanism is actuated. The release mechanism can be provided for access by a user.

Referring now to FIGS. 5 and 6, one or more lenses can be adjustable to facilitate movement when a force is applied thereto. As shown in FIG. 5, the second lens 244 can be positioned with respect to one or more components of the optical assembly 140. Where the optical assembly 140 includes a first lens 144 and/or a display, the second lens 244 can be positioned and adjustable with respect to any one or more of such components, including the most proximate portion of the optical assembly 140.

For example, the second lens 244 can initially be positioned to form a gap 198 between the second lens 244 and the optical assembly 140 (e.g., the first lens 144). The gap 198 can be any size to provide a range of motion to the second lens 244 before it contacts the first lens 144 or another component of the optical assembly 140 (e.g., a display). The gap 198 can be provided along an optical axis of the assembled system, such that the second lens 244 can provide a view to and/or through other components via the gap 198. It will be understood that such an arrangement can be achieved when the lens assembly 200 is releasably coupled to the optical assembly 140, as described herein.

The second lens 244 can be positioned in an initial position that can be maintained until an external force is provided thereto. For example, the lens assembly 200 can provide a recess 248 (e.g., notch, groove, and/or other structural feature) to support the second lens 244 in a stable position and/or orientation. The recess 248 can be formed by the lens assembly housing 242 and/or an elastic support 246. For example, one side of the recess 248 can be formed by the lens assembly housing 242, and another side of the recess 248 can be formed by the elastic support 246. The elastic support 246 can have an elastic modulus that is lower than elastic modulus of the lens assembly housing 242. For example, the elastic support 246 can have an elastic modulus of less than 1 GPa, less than 0.5 GPa, or less than 0.25 GPa. By further example, the lens assembly housing 242 can have an elastic modulus of greater than 1 GPa, greater than 0.5 GPa, or greater than 0.25 GPa. As such, the elastic support 246 deform or otherwise yield to give way to the second lens 244. In contrast, the lens assembly housing 242 can provide more rigid support, such that the second lens 244 does not deform the lens assembly housing 242. By further example, the second lens 244 can be supported in an initial position by one or more other mechanisms, such as detents, catches, latches, locks, and the like. In some embodiments, the second lens 244 is initially disposed within a recess 248 formed at least in part by the elastic support 246, the recess 248 defining a maximum inner cross-sectional dimension that is greater than a maximum inner cross-sectional dimension of the elastic support 246. As such, the second lens 244 can rest within the recess 248 based on a maximum outer cross-sectional dimension thereof (e.g., not exceeding the maximum inner cross-sectional dimension of the recess 248). As the second lens 244 moves against the elastic support 246, the maximum outer cross-sectional dimension thereof can deform the elastic support 246, which can have a relatively smaller maximum inner cross-sectional dimension compared to the second lens 244.

As shown in FIG. 6, as the second lens 244 moves through the elastic support 246, the elastic support 246 can deform to receive and facilitate travel of the second lens 244 towards the optical assembly 140. For example, an initial external force can be required to cause the second lens 244 to begin to move through the elastic support 246 (e.g., by deforming the elastic support 246). The second lens 244 can move through the elastic support 246, at least until the second lens 244 contacts a component of the optical assembly 140, such as the first lens 144. It will be understood that the range of motion can be controlled and/or limited by other features, such as features of the lens assembly 200.

It will be understood that adjustment of the second lens 244 can be controllable by a user and/or an actively controlled system. The adjustment of the second lens 244 can be reversible and/or otherwise readjustable, such that the second lens 244 can be moved to different positions as desired. While only one recess 248 is illustrated, any number of recesses 248 can be provided, with each providing a corresponding preferred alignment of the second lens 244. The second lens 244 can be accessible as an innermost terminal portion of the total optical pathway, such that the second lens 244 is a component facing (e.g., closest to) the user when the head-mountable device is worn on a head of a user.

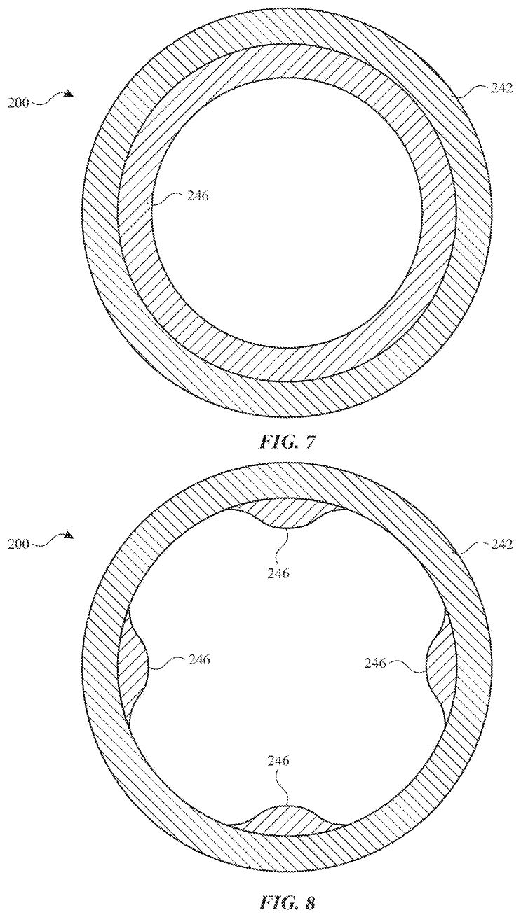

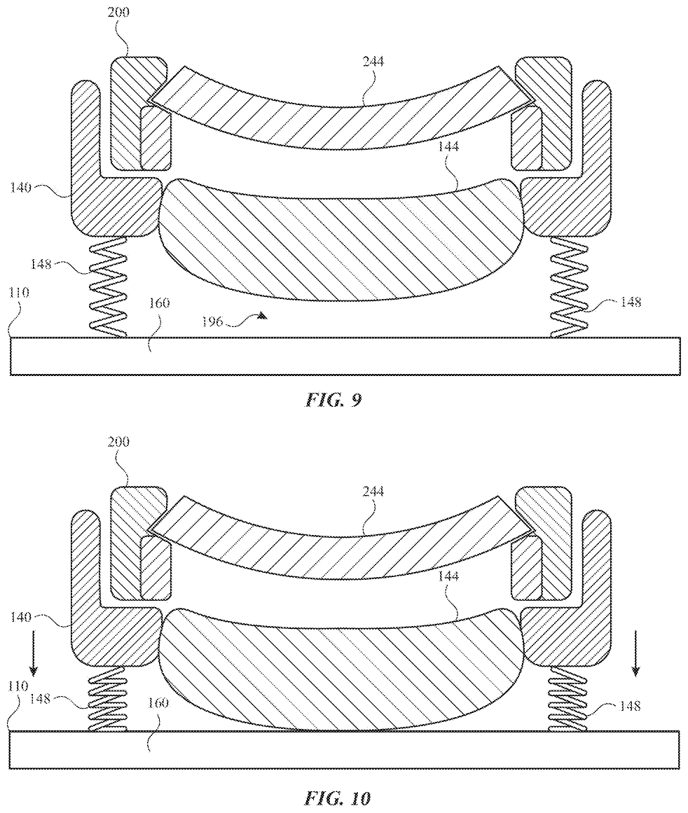

Referring now to FIGS. 7 and 8, the elastic support can have one or more of a variety of shapes and configurations to facilitate adjustment of a lens. As shown in FIG. 7, the elastic support 246 can form an annular ring that extends about an inner surface of the lens assembly housing 242. In some embodiments, the elastic support 246 can be circumferentially continuous. In some embodiments, the elastic support 246 can have a consistent inner cross-sectional dimension (e.g., diameter) about the entirety of its circumference.

As shown in FIG. 8, the elastic supports 246 can include multiple columns extending along an inner surface of the lens assembly housing 242. Each of the columns can be separated from one or a pair of circumferentially adjacent other columns. For example, groups, channels, notches, and/or gaps can be interposed between circumferentially adjacent pairs of columns forming the elastic supports 246. Accordingly, the elastic supports 246 can provide a variable inner cross-sectional dimension facing inwardly toward the space containing the lens. It will be understood that the individual columns of the elastic supports 246 can be independently formed or joined together.

It will be understood that a variety of shapes and/or sizes can be provided for one or more elastic supports 246. For example, the shapes that are sizes of features forming the elastic supports 246 can vary along the optical axis of the system, such that a lens traveling through the elastic supports 246 can encounter different shapes and/or sizes along the pathway. Such variation can provide different characteristics for interactions between the lens and elastic supports 246.

It will be further understood that the lens can have one or more of a variety of shapes and/or sizes. In some embodiments, the lens can have a shape that is the same or congruent to a shape of the elastic supports 246. In some embodiments, the lens can have a shape that engages different portions of the elastic supports 246 in particular ways. For example, an interaction between the lens and the elastic supports can facilitate movement along an axis without changing the orientation of the lens with respect to the elastic supports 246 and/or the lens assembly housing 242. By further example, other interactions between the lens and the elastic supports can facilitate controlled movements with correspondingly controlled changes in the orientation of the lens.

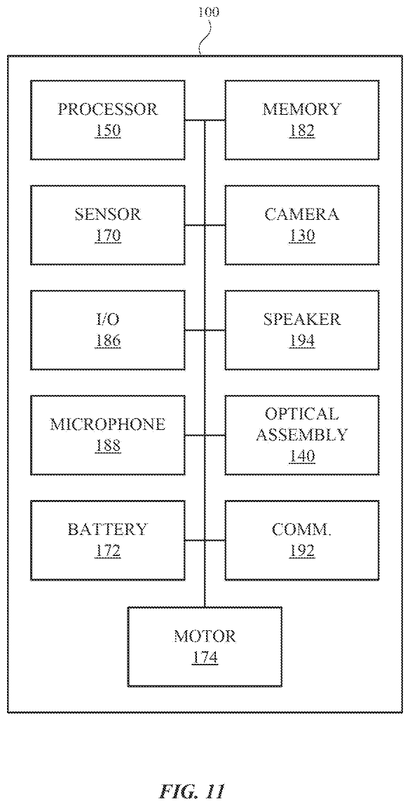

Referring now to FIGS. 9 and 10, both the lens assembly and the optical assembly can be provided with mechanisms that facilitate a range of motion to both. As shown in FIG. 9, the lens assembly 200 can be provided in an engaged arrangement with respect to the optical assembly 140. The optical assembly 140 can thereafter move with respect to the frame 110 and/or the display 160 for adjustment.

For example, the first lens 144 can initially be positioned to form a gap 196 between the first lens 144 and the frame 110 and/or the display 160. The gap 196 can be any size to provide a range of motion to the first lens 144 before it contacts the frame 110 and/or the display 160. The gap 196 can be provided along an optical axis of the assembled system, such that the first lens 144 can provide a view to and/or through other components via the gap 196.

The first lens 144 can be positioned in an initial position that can be maintained until an external force is provided thereto. For example, a spring 148 can bias the optical assembly 140 to a preferred position. The spring 148 can deform or otherwise yield to allow the optical assembly 140 to move, along with the first lens 144 and, if coupled, the lens assembly 200. By further example, the optical assembly 140 can be supported in an initial position by one or more other mechanisms, such as detents, catches, latches, locks, and the like. In some embodiments, the first lens 144 is initially disposed within the optical assembly in a manner that is similar or identical to the arrangement of the second lens 244 (e.g., with an elastic support).

As shown in FIG. 10, as the optical assembly 140 moves, the spring 148 can deform to receive and facilitate travel of the optical assembly 140 towards the frame 110 and/or the display 160. The spring 148 can also return the optical assembly 140 to the prior position when the external force is released.

It will be understood that adjustment of the optical assembly 140, including the first lens 144, can be controllable by a user and/or an actively controlled system. The adjustment of the optical assembly 140 can be reversible and/or otherwise readjustable, such that the optical assembly 140 can be moved to different positions as desired.

Referring now to FIG. 11, components of the head-mountable device can be operably connected to provide the performance described herein. FIG. 11 shows a simplified block diagram of an illustrative head-mountable device 10 in accordance with one embodiment of the invention. It will be appreciated that components described herein can be provided on one, some, or all of an HMD assembly, an optical assembly, a lens assembly, and/or a head engager. It will be understood that additional components, different components, or fewer components than those illustrated may be utilized within the scope of the subject disclosure.

As shown in FIG. 11, the head-mountable device 10 can include a processor 150 (e.g., control circuitry) with one or more processing units that include or are configured to access a memory 182 having instructions stored thereon. The instructions or computer programs may be configured to perform one or more of the operations or functions described with respect to the head-mountable device 10. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The processor can be a component of and/or operably connected to the control board and/or another component of the head-mountable device.

The memory 182 can store electronic data that can be used by the head-mountable device 10. For example, the memory 182 can store electrical data or content such as, for example, audio and video files, documents and applications, device settings and user preferences, timing and control signals or data for the various assemblies, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 10 can include adjustment control components described herein, such as a motor 174, an actuator, and the like for moving components (e.g., optical assemblies 140) to a desired relative position and/or orientation.

The head-mountable device 10 can include one or more sensors 170, such as the sensors of a sensor assembly, as described herein.

The head-mountable device 10 can include an input/output component 186, which can include any suitable component for connecting head-mountable device 10 to other devices. Suitable components can include, for example, audio/video jacks, data connectors, or any additional or alternative input/output components. The input/output component 186 can include buttons, keys, or another feature that can act as a keyboard for operation by the user.

The head-mountable device 10 can include the microphone 188 as described herein. The microphone 188 can be operably connected to the processor 150 for detection of sound levels and communication of detections for further processing, as described further herein.

The head-mountable device 10 can include the speakers 194 as described herein. The speakers 194 can be operably connected to the processor 150 for control of speaker output, including sound levels, as described further herein.

The head-mountable device 10 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 10 can include a battery 172, which can charge and/or power components of the head-mountable device 10. The battery 172 can also charge and/or power components connected to the head-mountable device 10 (e.g., the lens assembly 200).

Accordingly, embodiments of the present disclosure provide a head-mountable device with assemblies that provide vision correction with lenses. By providing head-mountable devices with modular features, certain lens assemblies can provide the desired vision correction for any given user and facilitate exchange with a different lens assembly for a different user. Within given assemblies, a lens or lenses can be moved within the corresponding housing such that they move with respect to other structures, such as other lenses and/or a display. Such movements can be managed by an elastic support that initially provides stability to the lens but can deform to allow the lens to move through the elastic support when sufficient force in a particular direction is applied.

Various examples of aspects of the disclosure are described below as clauses for convenience. These are provided as examples, and do not limit the subject technology.
Clause A: a head-mountable device comprising: a frame; an optical assembly supported by the frame, the optical assembly comprising a display; a lens separated from the optical assembly by a gap; and an elastic support connecting the lens to the optical assembly, wherein, when a force exceeding a threshold is applied to the lens, the elastic support is configured to move toward the display.
Clause B: a lens assembly for a head-mountable device, the lens assembly comprising: a housing configured to engage the head-mountable device; a lens; and an elastic support coupling the lens to the housing, the elastic support being deformable to allow the lens to travel with respect to the housing.
Clause C: a head-mountable device comprising: a frame; an optical assembly supported by the frame, the optical assembly comprising: a first lens; and a display; and a lens assembly comprising: a housing configured to engage the optical assembly; and a second lens, wherein the second lens is moveable with respect to the first lens while the housing is engaged to the optical assembly.

One or more of the above clauses can include one or more of the features described below. It is noted that any of the following clauses may be combined in any combination with each other, and placed into a respective independent clause, e.g., clause A, B, or C.
Clause 1: a lens assembly comprising the lens and a lens assembly connector, wherein the optical assembly further comprises an optical assembly connector configured to releasably engage the lens assembly connector.
Clause 2: the lens provides a view to the display when the lens assembly is coupled to the optical assembly with the lens assembly connector and the optical assembly connector.
Clause 3: the display and the lens are supported by a housing of the optical assembly, the lens being coupled to the housing by the elastic support.
Clause 4: the lens is disposed within a recess formed at least in part by the elastic support, the recess defining a maximum inner cross-sectional dimension that is greater than a maximum inner cross-sectional dimension of the elastic support.
Clause 5: the lens is supported between a housing and the elastic support, wherein the elastic support has an elastic modulus that is lower than an elastic modulus of the housing.
Clause 6: the elastic support is between the lens and the display.
Clause 7: a camera; a microphone; a speaker; and a head engager configured to secure the frame to a head, the frame supporting the camera, the microphone, the speaker, and the optical assembly.
Clause 8: the elastic support forms an annular ring extending continuously within the housing.
Clause 9: the elastic support comprises multiple columns extending along an inner surface of the housing and circumferentially separated from each other by grooves.
Clause 10: a lens assembly connector configured to releasably engage to an HMD assembly engager of the head-mountable device.
Clause 11: the lens is disposed within a recess formed at least in part by the elastic support, the recess defining a maximum inner cross-sectional dimension that is greater than a maximum inner cross-sectional dimension of the elastic support.
Clause 12: the lens is supported between the housing and the elastic support.
Clause 13: the elastic support has an elastic modulus that is lower than an elastic modulus of the housing.
Clause 14: the lens assembly further comprises an elastic support coupling the second lens to the housing, the elastic support being deformable to allow the second lens to travel with respect to the housing.
Clause 15: the optical assembly is moveably coupled to the frame by a spring.
Clause 16: the optical assembly further comprises an optical assembly connector; and the lens assembly further comprises a lens assembly connector configured to releasably engage the optical assembly connector to secure the lens assembly with respect to the optical assembly.

As described above, one aspect of the present technology may include the gathering and use of data. The present disclosure contemplates that in some instances, this gathered data may include personal information or other data that uniquely identifies or can be used to locate or contact a specific person. The present disclosure contemplates that the entities responsible for the collection, disclosure, analysis, storage, transfer, or other use of such personal information or other data will comply with well-established privacy policies and/or privacy practices. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” assembly may refer to one or more assemblies. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a frame;
an optical assembly supported by the frame, the optical assembly comprising a display;
a lens separated from the optical assembly by a gap; and
an elastic support connecting the lens to the optical assembly, wherein, when a force exceeding a threshold is applied to the lens, the elastic support is configured to move toward the display.

2. The head-mountable device of claim 1, further comprising a lens assembly comprising the lens and a lens assembly connector, wherein the optical assembly further comprises an optical assembly connector configured to releasably engage the lens assembly connector.

3. The head-mountable device of claim 2, wherein the lens provides a view to the display when the lens assembly is coupled to the optical assembly with the lens assembly connector and the optical assembly connector.

4. The head-mountable device of claim 1, wherein the display and the lens are supported by a housing of the optical assembly, the lens being coupled to the housing by the elastic support.

5. The head-mountable device of claim 1, wherein the lens is disposed within a recess formed at least in part by the elastic support, the recess defining a maximum inner cross-sectional dimension that is greater than a maximum inner cross-sectional dimension of the elastic support.

6. The head-mountable device of claim 1, wherein the lens is supported between a housing and the elastic support, wherein the elastic support has an elastic modulus that is lower than an elastic modulus of the housing.

7. The head-mountable device of claim 1, wherein the elastic support is between the lens and the display.

8. The head-mountable device of claim 1, further comprising:
a camera;
a microphone;
a speaker; and
a head engager configured to secure the frame to a head, the frame supporting the camera, the microphone, the speaker, and the optical assembly.

9. A lens assembly for a head-mountable device, the lens assembly comprising:
a housing configured to engage the head-mountable device;
a lens; and
an elastic support coupling the lens to the housing, the elastic support being deformable to allow the lens to travel with respect to the housing.

10. The lens assembly of claim 9, wherein the elastic support forms an annular ring extending continuously within the housing.

11. The lens assembly of claim 9, wherein the elastic support comprises multiple columns extending along an inner surface of the housing and circumferentially separated from each other by grooves.

12. The lens assembly of claim 9, further comprising a lens assembly connector configured to releasably engage to an HMD assembly engager of the head-mountable device.

13. The lens assembly of claim 9, wherein the lens is disposed within a recess formed at least in part by the elastic support, the recess defining a maximum inner cross-sectional dimension that is greater than a maximum inner cross-sectional dimension of the elastic support.

14. The lens assembly of claim 9, wherein the lens is supported between the housing and the elastic support.

15. The lens assembly of claim 9, wherein the elastic support has an elastic modulus that is lower than an elastic modulus of the housing.

16. A head-mountable device comprising:
a frame;
an optical assembly supported by the frame, the optical assembly comprising:
a first lens; and
a display; and
a lens assembly comprising:
a housing configured to engage the optical assembly; and
a second lens, wherein the second lens is moveable with respect to the first lens while the housing is engaged to the optical assembly.

17. The head-mountable device of claim 16, wherein the lens assembly further comprises an elastic support coupling the second lens to the housing, the elastic support being deformable to allow the second lens to travel with respect to the housing.

18. The head-mountable device of claim 17, wherein the elastic support has an elastic modulus that is lower than an elastic modulus of the housing.

19. The head-mountable device of claim 16, wherein the optical assembly is moveably coupled to the frame by a spring.

20. The head-mountable device of claim 16, wherein:
the optical assembly further comprises an optical assembly connector; and
the lens assembly further comprises a lens assembly connector configured to releasably engage the optical assembly connector to secure the lens assembly with respect to the optical assembly.
